(19) United States
(12) Patent Application Publication
(10) Pub. No.: US 2002/0133553 A1
(43) Pub. Date: Sep. 19, 2002

(54) Information providing system, information providing method, information recording medium with information providing program recorded there, and information providing program

(76) Inventor: Noboru Shinozaki, Tokyo-to (JP)

Correspondence Address: NIXON & VANDERHYE P.C., 8th Floor, 1100 North Glebe Road, Arlington, VA, 22201, US

(21) Appl. No.: 10/095,098

(22) Filed: Mar. 12, 2002

(30) Foreign Application Priority Data
Mar. 13, 2001 (JP) P2001-71190

(51) Int. Cl. G06F 15/16

(52) U.S. Cl. 709/205

(57) ABSTRACT

The information providing system of the present invention comprises a map server capable of displaying a map through the Internet and an application server which accepts registration of a member who satisfies a predetermined condition; records the selected spot only when a spot on the displayed map is selected by the registered member; and permits the processing for spot information including at least display processing for displaying the spot information corresponding to the recorded spot through the Internet and setting processing for setting the content of the spot information, separately to the registered member and the other except the same registered member, according to the content of the processing.

### BACKGROUND OF THE INVENTION

1. Field of the Invention

The present invention relates to a technical field of an information providing system, an information providing method, an information recording medium with an information providing program recorded there, and an information providing program, and more particularly, to an information providing system and an information providing method for providing information corresponding to a point on a map, and an information recording medium with an information providing program for providing the same information, and the information providing program.

2. Description of the Related Art

Recently, information processing through a network such as the Internet and the like has been generally used, and under such a circumstance, a plurality of people often share the same information through the network.

Specifically, for example, a person opens a home page on a network based on one theme and the information included in the home page is shared among a plurality of subscribers including the opening person. Such sharing the information is generally in wide use.

In the current generally sharing form of information, usually it is only the members permitted by the person opening the home page that can browse and edit the shared information.

In the above conventional sharing form of information, however, since those who can receive the information on the theme corresponding to the home page are restricted to the predetermined members, it has a disadvantage that the information collected from a wider range cannot be shared among the members.

In consideration to the above problem, an object of the present invention is to provide an information providing system and an information providing method capable of collecting a lot of useful information from a wide range and distributing the same to the members, and an information recording medium with an information providing program for providing the same information in such a way, and the same information providing program.

### SUMMARY OF THE INVENTION

The above object of the present invention can be achieved by an information providing system provided with: a map display device such as a map server etc., which displays a map through a network; a member registration device such as an application server etc., which accepts registration of a member who satisfies a predetermined condition; a spot recording device such as an application server etc., which records the selected spot only when a spot on the displayed map is selected by the registered member; and a separately-permitting device such as an application server etc., which permits processing for the spot information corresponding to the recorded spot, according to the content of the processing, separately to the registered member and the other except said registered member, wherein said processing includes at least display processing for displaying the spot information through the network and setting processing for setting content of the spot information.

Since the processing including at least the displaying processing and the setting processing of the spot information is permitted to the registered member and the other except the same registered member separately, according to the content of the processing, it is possible to obtain the information of the recorded spot also from the person having viewed the spot information, of the others except the registered members. Hence, each member can obtain the useful information widely and distribute it to the members.

Therefore, the information providing system in which a member can widely obtain the useful information corresponding to a spot on a map after his or her member registration.

In one aspect of the information providing system of the present invention, the spot information includes at least spot content information such as a spot information etc., indicating the content of the recorded spot itself and spot associated information such as a memo information etc., concerned with the recorded spot, and the separately-permitting device permits the setting processing of the spot content information only to the registered member, and permits the setting processing of the spot associated information to the registered member and the other except said registered member.

Therefore, it is possible to collect the spot associated information widely from the general public, and it is possible to prevent the spot information from being changed carelessly.

In another aspect of the information providing system of the present invention, the setting processing of the spot associated information includes at least the setting processing of new spot associated information and the changing processing of the existing spot associated information.

Since the setting processing of the spot associated information includes at least the setting processing of the new spot associated information and the changing processing of the existing spot associated information, it is possible to collect the spot associated information widely from the general public and distribute it to the members.

In further aspect of the information providing system of the present invention, the separately-permitting device permits the member at least to either delete or change the spot information corresponding to the spot selected by the member's own self and to cancel the selection of the spot selected by the member's own self.

Since a member is permitted at least to either delete or change the spot information corresponding to the spot selected by the member's own self and to cancel the selection of the spot selected by the member's own self, a member can change the spot information corresponding to the spot selected by himself or herself at his or her own will.

In further aspect of the information providing system of the present invention, several kinds of public levels are set in the display processing, wherein said public level indicates range of a person who can view the spot information, and the separately-permitting device sets the different public level in which the registered member is permitted to view the information from the public level in which the other except the registered member is permitted to view the information.

Since the public level in which the registered member is permitted to view the information is different from the public level in which the other except the same registered member is permitted to view the information, the spot information visible only to the registered member and the other spot information can be displayed in a distinctive way.

In further aspect of the information providing system of the present invention, the separately permitting device permits only the member having selected and recorded the spot to set and change the public level corresponding to the selected spot.

Since only the member having selected and registered a spot is permitted to set and change the public level corresponding to the selected spot, the member having selected the spot can change the public level at his or her own will, and this system can prevent the other members except the above member having selected the spot or the general public from changing the spot information corresponding to the spot without permission.

In further aspect of the information providing system of the present invention, the member registration device accepts registration of a member group including one or a plurality of members who satisfy a predetermined condition, of all the registered members.

Since this system accepts registration of a member group including one or a plurality of members who satisfy a predetermined condition, of all the registered members, not only one member but also the member group can share the spot information.

In further aspect of the information providing system of the present invention, the public levels are divided into: a private public level in which only the member having selected the spot is permitted to view the spot information corresponding to the selected spot; a within-group public level in which only the members belonging to said member group including the member having selected the spot is permitted to view the spot information corresponding to the selected spot; and a general public level in which everyone is permitted to view the spot information corresponding to the selected spot.

Since the public level is separated into the private public level, the within-group public level, and the general public level, it is possible to set the public level of the spot information depending on the content of the visible information.

In further aspect of the information providing system of the present invention, at registration of a member group, the member that is a manager of the member group and the member belonging to said member group, other than the manager, are separately registered, and the separately-permitting device permits the member registered as the manager at least to either delete or change the spot information corresponding to the spot selected by the other member belonging to said member group of the above manager member, and to cancel the selection of the spot selected by the other member.

Since the member registered as the manager is permitted to either delete or change the spot information corresponding to the spot selected by the other member belonging to the same member group and to cancel the selection of the spot selected by the other member, the member that is the manager can control the spot information within its member group collectively.

The above object of the present invention can be achieved by an information providing method provided with: a map display process for displaying a map through a network; a member registration process for accepting registration of a member who satisfies a predetermined condition; a spot recording process for recording the selected spot only when a spot on the displayed map is selected by the registered member; and a separately-permitting process for permitting processing for the spot information corresponding to the recorded spot, according to the content of the processing, separately to the registered member and the other except said registered member, wherein said processing includes at least display processing for displaying the spot information through the network and setting processing for setting content of the spot information.

Since the processing including at least the displaying processing and the setting processing of the spot information is permitted to the registered member and the other except the same registered member separately, according to the content of the processing, it is possible to obtain the information of the recorded spot also from the person having viewed the spot information, of the others except the registered members. Hence, each member can obtain the useful information widely and distribute it to the members.

Therefore, according to the information providing method, a member can widely obtain the useful information corresponding to a spot on a map after his or her member registration.

In one aspect of the information providing method of the present invention, the spot information includes at least spot content information indicating the content of the recorded spot itself and spot associated information concerned with the recorded spot, and in the separately-permitting process, the setting processing of the spot content information is permitted only to the registered member, and the setting processing of the spot associated information is permitted to the registered member and the other except said registered member.

Therefore, it is possible to collect the spot associated information widely from the general public, and it is possible to prevent the spot information from being changed carelessly.

In another aspect of the information providing method of the present invention, the setting processing of the spot associated information includes at least the setting processing of new spot associated information and the changing processing of the existing spot associated information.

Since the setting processing of the spot associated information includes at least the setting processing of the new spot associated information and the changing processing of the existing spot associated information, it is possible to collect the spot associated information widely from the general public and distribute it to the members.

In further aspect of the information providing method of the present invention, in the separately-permitting process, the member is permitted at least to either delete or change the spot information corresponding to the spot selected by the member's own self and to cancel the selection of the spot selected by the member's own self.

Since a member is permitted to either delete or change the spot information corresponding to the spot selected by the member's own self and to cancel the selection of the spot selected by the member's own self, a member can change the spot information corresponding to the spot selected by himself or herself at his or her own will.

In further aspect of the information providing method of the present invention, several kinds of public levels are set in the display processing, wherein said public level indicates range of a person who can view the spot information; and in the separately-permitting process, the public level in which the registered member is permitted to view the information is set different from the public level in which the other except the registered member is permitted to view the information.

Since the public level in which the registered member is permitted to view the information is different from the public level in which the other except the same registered member is permitted to view the information, the spot information visible only to the registered member and the other spot information can be displayed in a distinctive way.

In further aspect of the information providing method of the present invention, in the separately permitting process, only the member having selected and recorded the spot is permitted to set and change the public level corresponding to the selected spot.

Since only the member having selected and registered a spot is permitted to set and change the public level corresponding to the selected spot, the member having selected the spot can change the public level at his or her own will, and this method can prevent the other members except the above member having selected the spot or the general public from changing the spot information corresponding to the spot without permission.

In further aspect of the information providing method of the present invention, registration of a member group including one or a plurality of members who satisfy a predetermined condition, of all the registered members, is accepted in the member registration process.

According to this method, since registration of a member group including one or a plurality of members who satisfy a predetermined condition, of all the registered members, is accepted, not only one member but also the member group can share the spot information.

In further aspect of the information providing method of the present invention, the public levels are divided into: a private public level in which only the member having selected the spot is permitted to view the spot information corresponding to the selected spot; a within-group public level in which only the members belonging to said member group including the member having selected the spot is permitted to view the spot information corresponding to the selected spot; and a general public level in which everyone is permitted to view the spot information corresponding to the selected spot.

Since the public level is separated into the private public level, the within-group public level, and the general public level, it is possible to set the public level of the spot information depending on the content of the visible information.

In further aspect of the information providing method of the present invention, at registration of a member group, the member that is a manager of the member group and the member belonging to said member group, other than the manager, are separately registered, and in the separately-permitting process, the member registered as the manager is permitted at least to either delete or change the spot information corresponding to the spot selected by the other member belonging to said member group of the above manager member, and to cancel the selection of the spot selected by the other member.

Since the member registered as the manager is permitted to either delete or change the spot information corresponding to the spot selected by the other member belonging to the same member group and to cancel the selection of the spot selected by the other member, the member that is the manager can control the spot information within its member group collectively.

The above object of the present invention can be achieved by an information recording medium with an information providing program recorded in a computer-readable way, whereby a computer included in an information providing system capable of providing information through a network works as: a map display device which displays a map through a network; a member registration device which accepts registration of a member who satisfies a predetermined condition; a spot recording device which records the selected spot only when a spot on the displayed map is selected by the registered member; and a separately-permitting device which permits processing for the spot information corresponding to the recorded spot, according to the content of the processing, separately to the registered member and the other except said registered member, wherein said processing includes at least display processing for displaying the spot information through the network and setting processing for setting content of the spot information.

Since a computer works to permit the processing including at least the displaying processing and the setting processing of the spot information to the registered member and the other except the same registered member separately, according to the content of the processing, it is possible to obtain the information of the recorded spot also from the person having viewed the spot information, of the others except the registered members. Hence, each member can obtain the useful information widely and distribute it to the members.

Therefore, the information providing system in which a member can widely obtain the useful information corresponding to a spot on a map after his or her member registration can be realized.

The above object of the present invention can be achieved by an information providing program which lets a computer included in an information providing system capable of providing information through a network, work as: a map display device which displays a map through a network; a member registration device which accepts registration of a member who satisfies a predetermined condition; a spot recording device which records the selected spot only when a spot on the displayed map is selected by the registered member; and a separately-permitting device which permits processing for the spot information corresponding to the recorded spot, according to the content of the processing, separately to the registered member and the other except said registered member, wherein said processing includes at least display processing for displaying the spot information through the network and setting processing for setting content of the spot information.

Since a computer works to permit the processing including at least the displaying processing and the setting processing of the spot information to the registered member and the other except the same registered member separately, according to the content of the processing, it is possible to obtain the information of the recorded spot also from the person having viewed the spot information, of the others except the registered members. Hence, each member can obtain the useful information widely and distribute it to the members.

Therefore, the information providing system in which a member can widely obtain the useful information corresponding to a spot on a map after his or her member registration can be realized.

### BRIEF DESCRIPTION OF THE DRAWINGS

FIG. 1 is a block diagram showing the schematic structure of the information providing system according to the embodiment;

FIGS. 2A, 2B, 2C, and 2D show a list indicating the contents of setting authority of each public level attached to each member in the embodiment, when combined;

FIG. 3 is a flow chart showing the whole structure of the information providing processing above;

FIG. 4 is a flow chart showing the details of the trial registration;

FIG. 5 is a view showing a screen example displayed on a personal computer PC in the trail registration processing;

FIG. 6 is a flow chart sowing the details of the attribute changing processing;

FIG. 7 is a flow chart showing the details of the normal registration processing;

FIGS. 8 to 11 are views each showing a screen example displayed on the personal computer PC in the normal registration processing;

FIG. 12 is a flow chart showing the details of the attribute changing processing;

FIG. 13 is a flow chart showing the information providing processing;

FIG. 14 is a flow chart showing the setting processing of the public level;

FIG. 15 is a flow chart showing the operation of the memo information;

FIGS. 16 to 19 are examples of screens displayed on the personal computer PC in the information providing processing.

### DESCRIPTION OF THE PREFERRED EMBODIMENT

A preferred embodiment according to the present invention will be described based on the drawings.

The embodiment described below is in the case of adopting the present invention to an information providing system for providing the information registered associated with a selected point on a map to a plurality of members who have a predetermined condition (hereinafter, properly referred to as membership).

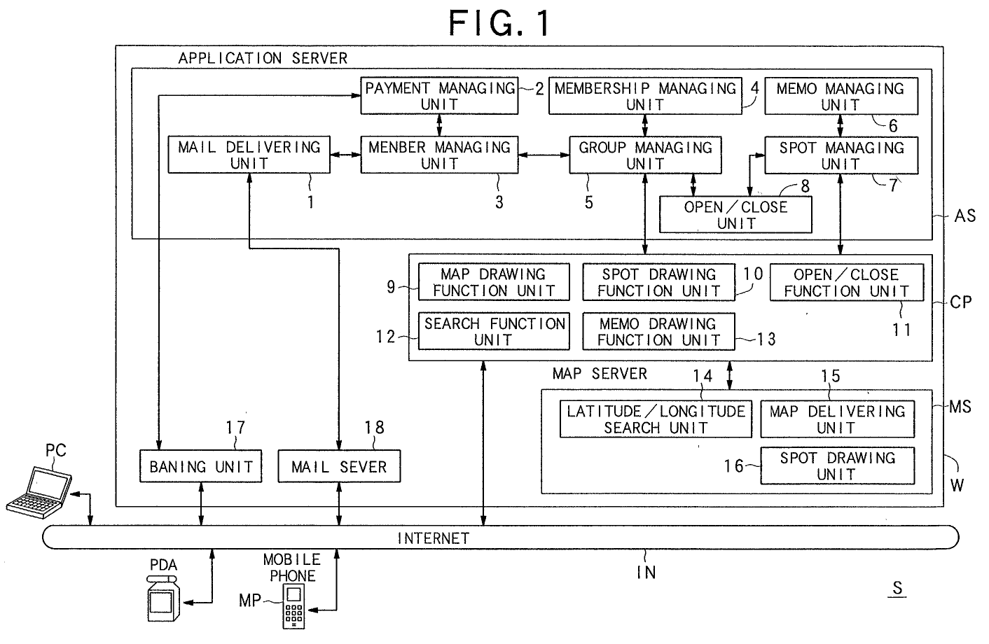

At first, the schematic structure of the information providing system according to the embodiment will be described by using FIG. 1 that is a block diagram showing the above.

As illustrated in FIG. 1, the information providing system S according to the embodiment is formed by an information providing server W which can permit a member satisfying a predetermined condition and the general public including the same member to browse spot information and the like described below which has been registered associated with a point on a map (a spot described below) selected and registered by the same member, under a condition, and a personal computer PC, a personal digital assistant PDA, and a mobile phone MP which can be connected to the above information providing server W through the Internet IN and operated by the member in order to browse and register the spot information.

Since the personal computer PC, the personal digital assistant PDA, and the mobile phone MP have the same function in the information providing system S of the embodiment, they are collectively referred to as a personal computer PC in the following description.

The information providing server W is formed by an application server AS, as a member registering device, a map recording device, and a classification permitting device, a central processing unit CP, a map server MS as a map browsing device, a mail server 18, and a banking unit 17.

The banking unit 17 and the mail server 18 are possible to intervene between the Internet IN and the application server AS to transfer information therebetween.

The application server AS is formed by a mail delivering unit 1, a payment managing unit 2, a member managing unit 3, a membership managing unit 4, a group managing unit 5, a memo managing unit 6, a spot managing unit 7, and an open/close unit 8.

The mail delivering unit 1 can transfer information to and from the mail server and the member managing unit 3. The member managing unit 3 can transfer information to and from the mail delivering unit 1, the payment managing unit 2, and the group managing unit 5. The payment managing unit 2 can transfer information to and from the member managing unit 3 and the banking unit 17. The group managing unit 5 can transfer information to and from the central processing unit CP, the member managing unit 3, the membership managing unit 4, and the open/close unit 8. The open/close unit 8 can transfer information to and from the group managing unit 5 and the spot managing unit 7. The spot managing unit 7 can transfer information to and from the open/close unit 8, the central processing unit CP, and the memo managing unit 6. The memo managing unit 6 can transfer information to and from the spot managing unit 7 only.

Then, the map server MS can transfer information to and from the central processing unit CP. Concretely, it is formed by a latitude/longitude search unit 14, a map delivering unit 15, and a spot drawing unit 16.

The central processing unit CP can transfer information to and from the group managing unit 5, the spot managing unit 7, the map server MS, and the Internet IN. Concretely, it is formed by a map drawing function unit 9, a spot drawing function unit 10, an open/close function unit 11, a search function unit 12, and a memo drawing function unit 13.

A schematic operation of each unit will be described.

The mail server 18 collectively manages an electronic mail to be transferred between the information providing server W and the personal computer PC through the Internet IN.

While, the banking unit 17 manages the information of a credit card and the like to be transferred between the information providing server W and the personal computer PC through the Internet IN, for the settlement of membership costs which should be paid at a member registration described later.

The mail delivering unit 1 within the application server AS receives an electronic mail sent from the personal computer PC through the mail server 18 and manages the sending source and the received date of the electronic mail. It also sends an electronic mail to the personal computer PC through the mail server 18 and manages the sending destination and the sent data of the electronic mail.

The payment managing unit 2 manages the information of the received money entered through the banking unit 17 for every member, and when there arises a necessity of sending an electronic mail to a member, for example, in the case of unpaid membership costs in each member, it supplies to the effect to the member managing unit 3.

While transferring information to and from the mail delivering unit 1, the payment managing unit 2, and the group managing unit 5, the member managing unit 3 performs the managing processing of members (more particularly, including the registration processing of a new member, the withdrawing processing of a member, and the membership costs managing processing). When receiving a sending request of an electronic mail from the payment managing unit 2, the member managing unit 3 supplies to this effect to the mail delivering unit 1, and controls the mail delivering unit 1 to send the necessary electronic mail to a member.

The membership managing unit 4 manages the addresses and the contact addresses of the membership (members) belonging to a group formed by one or a plurality of members.

While transferring information to and from the membership managing unit 4, the group managing unit 5 manages the items relative to the whole group (the record of transition in the number of the members and the record of the established date). As described later, when a member within the group registers a new spot described later, the information is supplied from the Internet IN to the group managing unit 5 through the central processing unit CP and managed there.

The memo managing unit 6 records the content of the memo information as the point associated information described later and manages the registered date and registered point concerned.

The spot managing unit 7 records the content of the spot information as the point content information indicating the content of a spot on a map concerned with the memo information as well as the content of the memo information managed by the memo managing unit 6.

Moreover, the open/close unit 8 manages the public level described later, respectively as for the above-mentioned memo information and spot information.

While, the latitude/longitude search unit 14 within the map server MS searches for the latitude and longitude of a spot registered on the described registration screen. At this time, in a stage of registration on the registration screen, a point is selected on a displayed map, hence to select and register a spot. The latitude and longitude, however, are not supplied there as the information indicating the spot, but only a point is selected and registered as the address information on a map in this stage.

The map delivering unit 15 supplies the necessary map information for displaying a map to the central processing unit CP, to deliver the map which is desired to be displayed by the personal computer PC through the Internet IN.

The spot drawing unit 16 draws and supplies a spot on the map when the above map information is supplied from the information providing server W.

The map drawing function unit 9 within the central processing unit CP creates the map information to be sent to the PC through the Internet IN based on the map information supplied from the map delivering unit 15 and supplies it to the Internet IN.

Just at an output time of the map information to the Internet IN, the spot drawing function unit 10 and the memo drawing function unit 13 add the spot information and the memo information to the map information and supply the same to the Internet IN.

Moreover, the open/close function unit 11 actually controls the opening state of the spot information and the memo information based on an open/close condition established by the member, in supplying the spot information and the memo information.

Finally, when browsing of spot information is requested from the personal computer PC through the Internet IN, the search function unit 12 searches for the necessary spot information corresponding to the requested spot information, and delivers the searched spot information to the personal computer PC having requested the browsing, under a control of the public range by the open/close function unit 11.

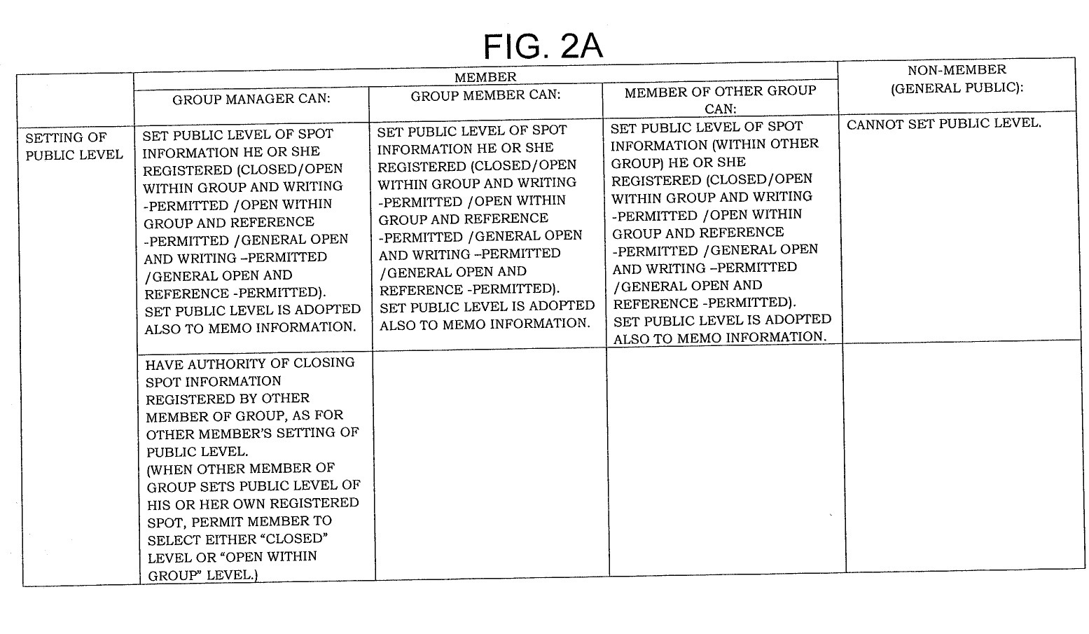

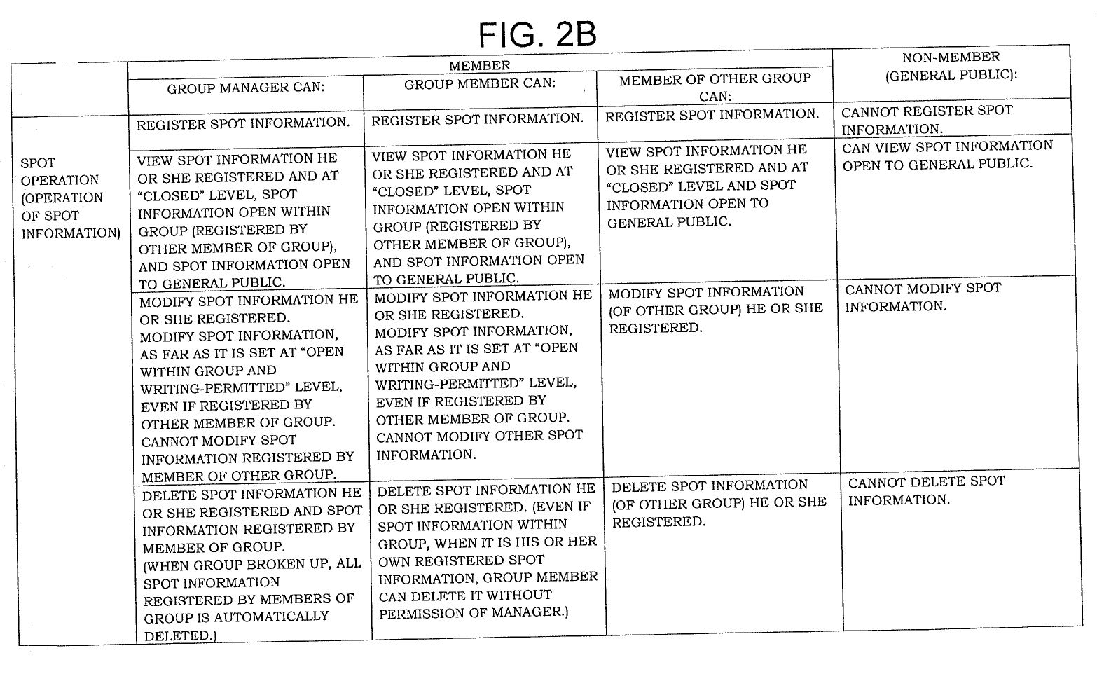

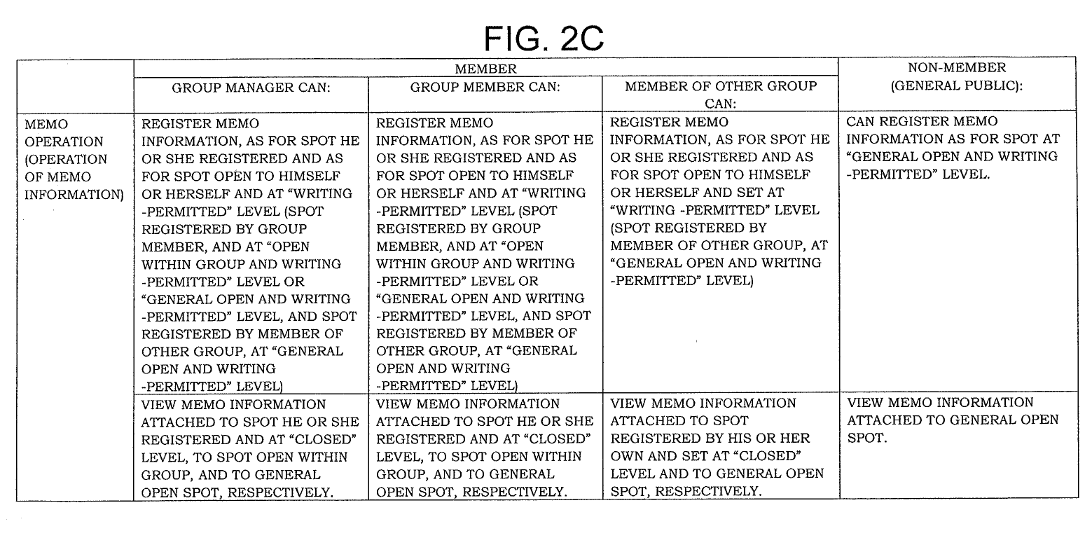

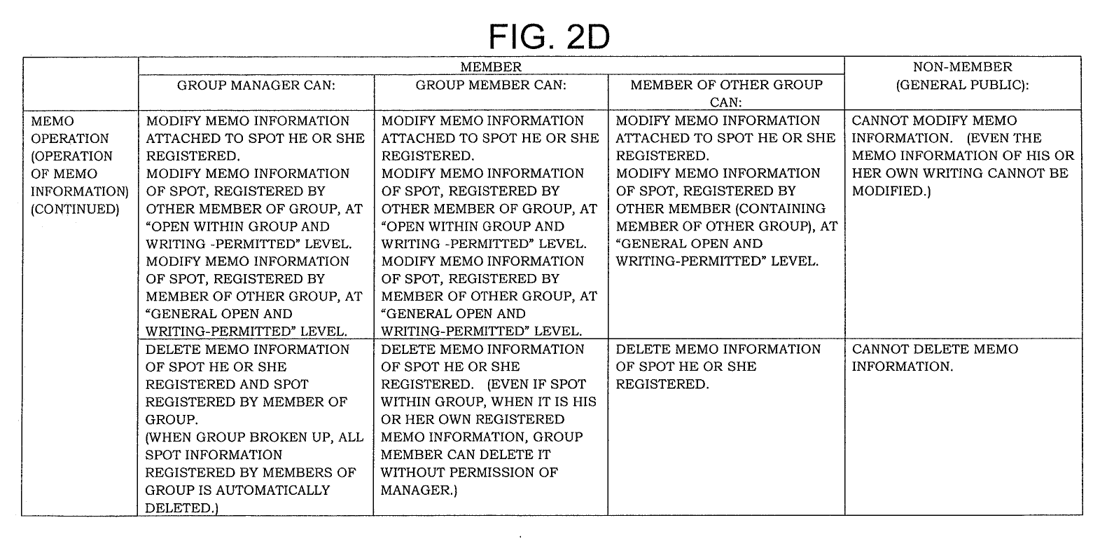

The information providing processing of the embodiment to be performed in the information providing server S having the above-mentioned respective functions will be described by using FIGS. 2A, 2B, 2C, 2D, and 3 to 19.

A spot, the spot information, the memo information, and the public levels thereof to the general public will be described by using FIGS. 2A, 2B, 2C, and 2D. FIGS. 2A, 2B, 2C, and 2D show a list indicating the contents of setting authority of each public level attached to each member in the embodiment, when combined.

In the information providing system S in the embodiment, one or several groups including one or several members are formed for the purpose of sharing the information according to a specified theme. Each member forming the group is allowed to register the spot as a position on a map. Simultaneously to this registration of the spot, each member is allowed to register the spot information corresponding to the registered spot.

The spot information corresponding to the spot includes the information of the latitude and the longitude indicating the position of the spot registered on the map, the title of the spot for registration and the name of the member as the registrant, and further the image information concerned with the spot can be registered therein.

The registered spot and the registered spot information can be set to be disclosed under authority of the member who performed its registration (hereinafter, properly referred to as a registrant). At this time, although the public range of the information can be set by a registrant according to the setting of the public level described later, the information can be disclosed also to the general public other than the members, depending on the content of the spot information.

Further, the information providing system S of the embodiment can be set in a way of allowing a member other than a registrant and the general public other than the member to attach the information concerned with the spot to a spot and the spot information disclosed under the authority of the registrant. The associated information attached at this time is the above memo information, and the memo information can be edited even by the general public who is not a member (all people that can connect to the information providing server W). Namely, when using the information providing server W in order to manage the information only for his or her own, a member forming a group can set the spot and the spot information open only within the group, while when the member wants to collect a lot of information about the registered spot, he or she can set the spot and the spot information open to the general public, thereby collecting various information from the general public.

Although the above-mentioned spot information and memo information are completely equal to each other in a sense that the both information is the information having the content concerned with the spot and attached to the spot, the spot information and the memo information are formed by the items different from each other.

Namely, the spot information is the basic information indicating the content of the spot (more specifically, the name of the spot, the latitude and the longitude indicating its position), while the memo information is the writable information (more specifically, the feeling when visiting a shop at a position on a map registered as the spot, and the information of the scene at the position).

An operation can be added to the spot information. Specifically, the operation includes registration (write), reference (browsing), modification, and deletion. While, an operation can be added to the memo information, similarly. Specifically, the operation includes registration (write), reference (browsing), modification, and deletion.

The above-mentioned public level will be described this time.

The public level of each spot and spot information registered as mentioned above mean a public level indicating how much degree the spot and the spot information are disclosed to respective classified persons, and a registrant of the respective spot information can set the public level.

The concrete public level includes five stages: (1) closed, (2) open within group (writable), (3) open within group (only browsing), (4) open to the general public (writable), and (5) open to the general public (only browsing).

Here, the level (1) closed means a public level in which only a registrant having registered the spot information can browse the same spot information, the level (2) open within group (writable) means a public level in which only the other members within the group which a registrant having registered the spot information belongs to and the registrant himself or herself can browse and edit the spot information, the level (3) open within group (only browsing) means a public level in which the other members within the group which a registrant having registered the spot information belongs to are permitted only to browse the spot information, the level (4) open to the general public (writable) means a public level in which the general public including the other members within the group which a registrant having registered the spot information belongs to is permitted to browse and edit the spot information, and the level (5) open to the general public (only browsing) means a public level in which the general public including the other members within the group which a registrant having registered the spot information belongs to is permitted only to browse the spot information.

The authority of each member including the details of the public level is indicated in a list of FIGS. 2A, 2B, 2C, and 2D. At this time, in the list, the above-mentioned spot itself and spot information are collectively referred to as “spot information”.

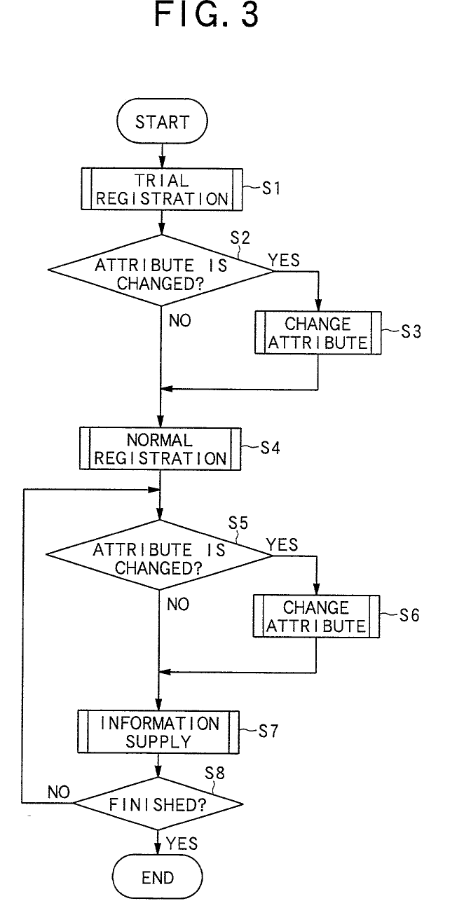

The information providing processing of the embodiment, under consideration of the constitution of the above authority shown in FIGS. 2A, 2B, 2C, and 2D, will be described by using FIGS. 3 to 19.

The whole structure of the information providing processing will be described by using FIG. 3 that is a flow chart showing the above.

As illustrated in FIG. 3, as the general form of the information providing processing of the embodiment, at first, a group is formed, by way of trial, based on a spot on a map, hence to perform a trial registration for examining the effectivity of the information providing processing of the embodiment (in step S1). Whether the attribute of the spot information registered by trial should be changed is checked (in step S2). When the attribute should not be changed (NO; in step S2), the processing will move to Step S4, while when the attribute should be changed (YES; in step S2), the corresponding attribute will be changed (in step S3).

As a result of the trial registration, when the information providing processing of the embodiment is judged to be effective, the original (normal) registration processing is performed (in step S4). Thereafter, whether the attribute of the registered spot information should be changed is checked (in step S5); when the attribute should not be changed (NO; in step S5), the processing will move to Step S7, while when the attribute should be changed (YES; in step S5), the corresponding attribute will be changed (in step S6). Further, the original information providing processing described later as the information providing server W will be performed (in step S7).

Whether the information providing processing should be finished or not is checked (in step S8); when it should not be finished (NO; in step S8), the processing will be returned to Step S5 again, where the above processing will be repeated, while when it should be finished (YES; in step S8), the whole information providing processing will be finished without doing anything.

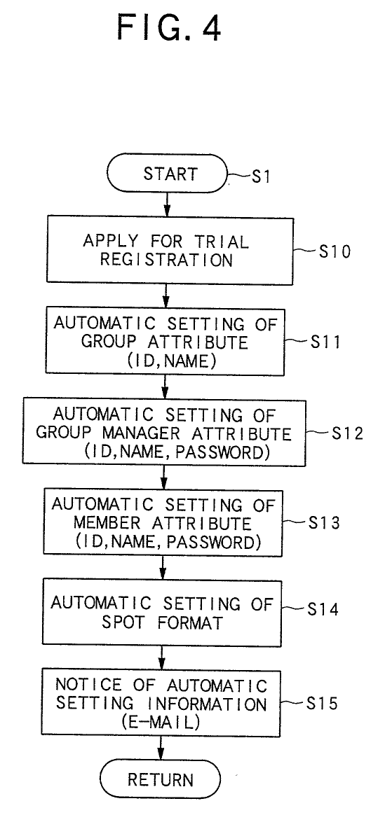

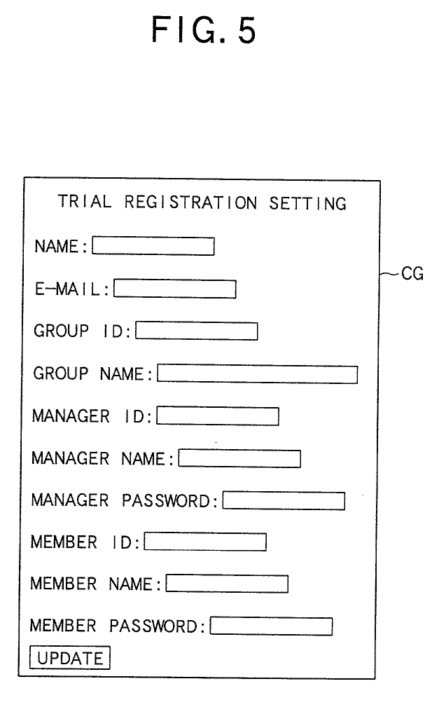

The details of the trial registration (in step S1) shown in FIG. 3 will be described by using FIG. 4 and FIG. 5.

FIG. 4 is a flow chart showing the details of the trial registration, and FIG. 5 is a view showing a screen example displayed on a personal computer PC in the trail registration processing.

More specifically, as the processing of the above-mentioned Step S1, when a registrant who tries the trial registration (in many cases, a person who should be a manager of the group in the future, but it is not restricted to the person) makes access to the information providing server W, a trail registration screen CG shown in FIG. 5 appears on the personal computer PC. The registrant inputs at least his or her own electronic mail address and name from the personal computer PC to ask for the trail registration (in step S10).

At this time, when the other information necessary for the setting of a group including the same registrant has not been entered yet, the other information (more specifically, group ID (group identification information), group name, ID of a group manager (manager identification information), manager's name, manager's password, member ID of a member to belong to the group (member identification information), member's name, and member's password) is automatically set temporarily (in steps S11 to S13).

At a point of completing an input operation up to Step S13, at the beginning of the trial registration, the member of the group proves to be only one trial registrant.

Upon completion of the setting of various information, a regular format for use in input and display of the spot, the spot information, and the memo information is automatically sent to the trail registrant as an example showing the registration state of the spot information and/or the memo information and the display state after its registration (in step S14), and at last, the information automatically set in Steps S11 to S13 is notified to the trial registrant according to the electronic mail address indicating the same trial registrant (in step S15), and the trial registration will be finished.

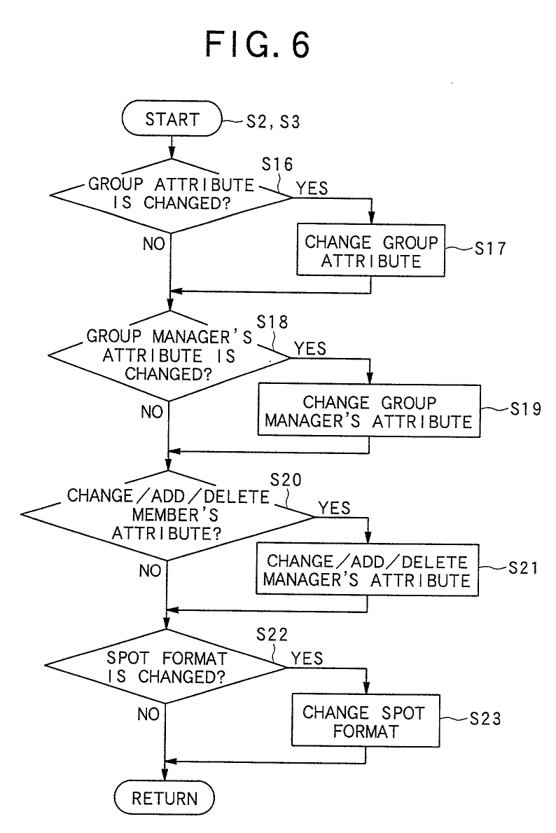

The changing processing of each attribute to be performed after the above trial registration and before the normal registration described later will be described by using FIG. 6. FIG. 6 is a flow chart sowing the details of the attribute changing processing.

As illustrated in FIG. 6, in the attribute changing processing after the trail registration, the trial registration screen CG indicated in FIG. 5 including the information notified in Step S15 is displayed on the personal computer PC. Whether it is necessary to change the group attribute (namely, the group ID and the group name) automatically set (or set by the manual setting thereafter) at the above trial registration is checked (in step S16); when it is necessary to change the above (YES; in step S16), the content is changed and registered (in step S17), and then the processing will move to Step S18, while when it is not necessary to change the above (No; in step S16), the processing will move to Step S18 directly.

Whether it is necessary to change the attribute of the group manager (namely, the manager's ID and the manager's name) automatically set (or set by the manual setting thereafter) at the above-mentioned trial registration is checked (in step S18); when it is necessary to change the above (YES; in step S18), the content is changed and registered (in step S19), and then the processing will move to Step S20, while when it is not necessary to change the above (NO; in step S18), the processing will move to Step S20 directly.

Whether it is necessary to change the member's attribute (namely, the member's ID and the member's name) within the group automatically set (or set by the manual setting thereafter) at the above-mentioned trial registration, is checked by using the displayed trial registration screen CG (in step S20); when it is necessary to change the above (YES; in step S20), the content is changed and registered (in step S21), and then the processing will move to Step S22, while when it is not necessary to change the above (NO; in step S20), the processing will move to Step S22 directly.

At last, whether it is necessary to change the regular format of the spot information automatically set (or set by the manual setting thereafter) at the above-mentioned trial registration, is checked by using the displayed trial registration screen CG (in step S22); when it is necessary to change the above (YES; in step S22), the content is changed and registered (in step S23), while it is not necessary to change the above (NO; in step S22), the attribute changing processing will be finished.

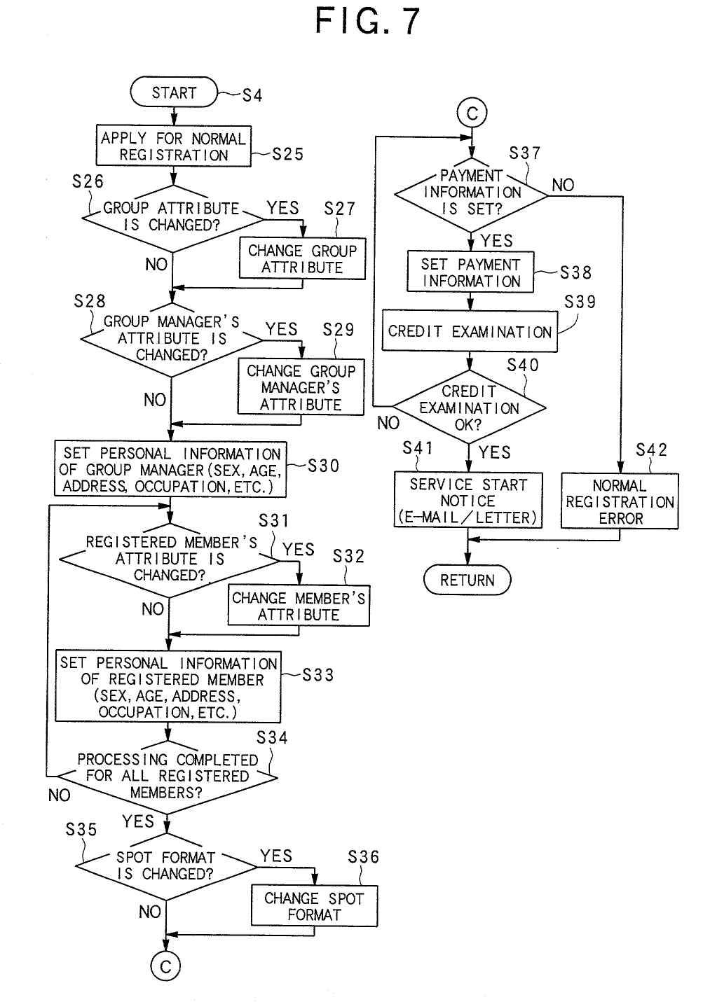

The details of the normal registration processing to be performed when the information providing processing of the embodiment is judged to be effective, as a result of the trial registration, will be described by using FIGS. 7 to 11.

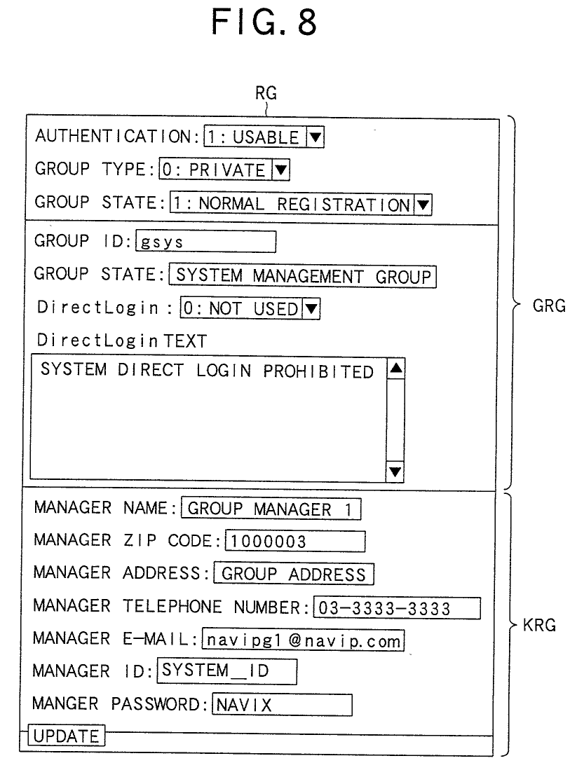

FIG. 7 is a flow chart showing the details of the normal registration processing, and FIGS. 8 to 11 are views each showing a screen example displayed on the personal computer PC in the normal registration processing.

In the normal registration processing of the embodiment, the personal information registered at the trial registration is more specifically registered again. Since the attributes are more often changed in the normal registration processing, the procedure of the normal registration processing also includes the processing of changing the attribute. The attribute changing processing can be properly performed also after the normal registration processing.

Namely, as illustrated in FIG. 7, in the normal registration processing of the embodiment, at first, when a registrant having performed the trial registration or a person who becomes a manager of the group gains access to the information providing server W, a normal registration screen RG shown in FIG. 8 is displayed on the personal computer PC. The registrant asks for the normal registration processing by using the normal registration screen RG (in step S25). Further, whether the attribute of the group (more specifically, the group ID and the group name) automatically set or temporarily set by hand at the trial registration should be changed, is checked (in step S26); when it should not be changed (NO; in step S26), the processing will move to Step S28, while when it should be changed (YES; in step S26), an item within the group registration screen GRG is supplied by using the group registration screen GRG in the normal registration screen RG, so to change the group attribute (in step S27) and the processing will move to Step S28.

Whether the attribute of the group manager automatically set or temporarily set by hand at the trial registration should be changed, is checked (in step S28); when it should not be changed (NO; in step S28), the processing will move to Step S30, while when it should be changed (YES; in step S28), an item within the manager registration screen KRG is supplied by using the manager registration screen KRG in the normal registration screen RG, thereby changing the attribute of the group manager (in step S29), and the processing will move to Step S30.

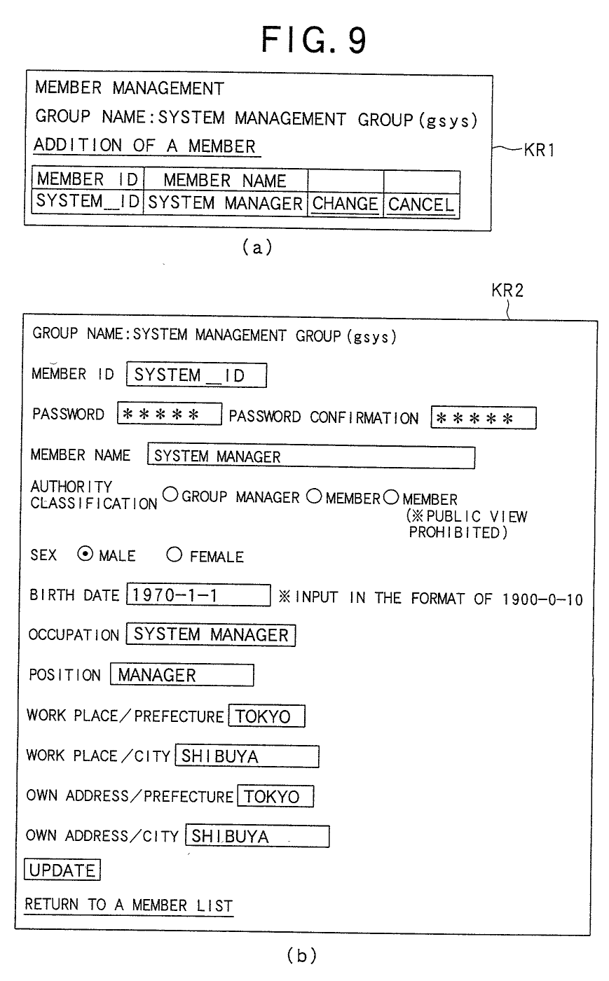

This time, the detailed information of a group manager in the normal registration processing (more specifically, authority classification as a manager, sex, birth date, the type of occupation, managerial position, work place, and his or her own house) is registered (in step S30). At this time, in entering the detailed information, a member management select screen KR1 indicated in FIG. 9(a) is displayed on the personal computer PC at first, and when a change of a group manager is selected therefrom, a detailed information input screen KR2 indicated in FIG. 9(b) is displayed. The detailed information of the group manager is registered by inputting necessary items on the detailed information input screen KR2.

Upon completion of the detailed information registration of the group manager, whether the manager changes the attribute of a member (more specifically, the member's ID, name and password) other than the manager belonging to the group automatically set or temporarily set by hand at the trial registration, is checked (in step S31). When the manager doesn't change it (NO; in step S31), the processing will move to Step S33 directly, while when the manager changes the attribute of the member other than himself or herself (YES; in step S31), a change of the member other than the manager is selected on the member management select screen KR1 shown in FIG. 9(a) and the detailed information input screen KR2 indicated in FIG. 9(b) is displayed, on which screen the manager newly enters the member's ID, name, and password (in step S32), and the processing will move to Step S33.

In the changing processing, by use of the column of the authority classification in the detailed information input screen KR2, the manager selects “member” if the spot information or the memo information registered by a member to be changed is disclosed to the general public, while the manager selects “member (prohibit a public view)” if the spot information or the memo information registered by the member to be changed is closed to the public. This processing enables the manager to determine whether he or she should authorize a member other than himself or herself to open the information within the group to the public.

By use of the detailed information input screen KR2 in the same way as in the case of the above Step S30, the manager registers the detailed information (more specifically, authority classification as a member, sex, birth date, the type of occupation, managerial position, work place, and his or her own house) of each member other than the manager in the normal processing (in step S33).

Whether the above-mentioned processing has been completed as for all the registered members, is checked (in step S34); when it has not been completed (NO; in step S34), the processing will be returned to Step S31 in order to perform the registration processing again as for a member having not been registered, while when it has been completed (YES; in step S34), whether the spot format temporarily generated in the trial registration processing should be changed depending on the characteristic of the group, is checked (in step S35); when it is not changed (NO; in step S35), the processing will move to Step S37 directly, while when it is changed (YES; in step S35), the spot format is changed (in step S36) and then the processing will move to Step S37.

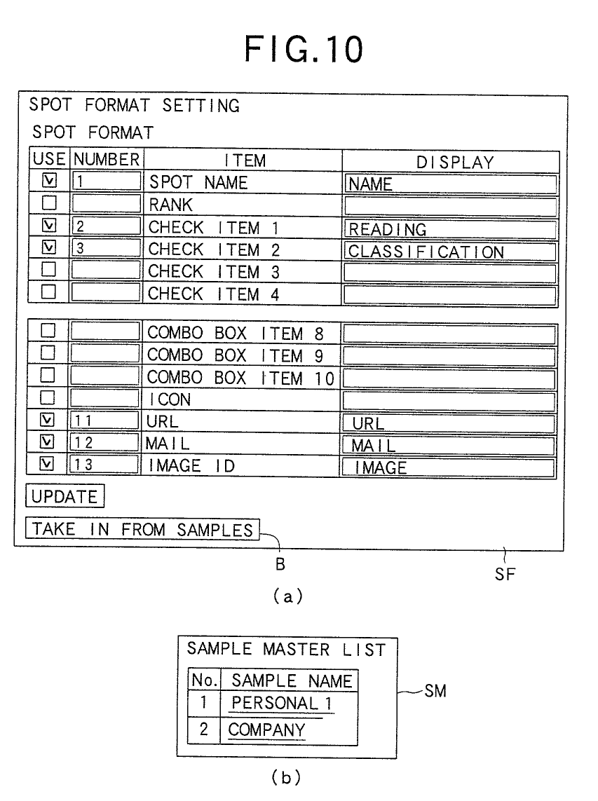

At this time, at first, a spot format setting screen SF as shown in FIG. 10(a) is displayed on the personal computer PC in Step S37. The manager specifically selects a column for use in information display of the group from the usable columns as the spot format, thereby to generate the spot format suitable for the purpose or the attribute of the group. The spot format includes a plurality of search items for searching for a spot and a plurality of combo boxes for registering the spot information and the memo information concerned with the spot, in addition to the tile of the spot and the ranking, as illustrated in FIG. 10(a).

On the spot format setting screen SF, when selecting a spot format from the samples briefly established in advance, a button B within the spot format setting screen SF is operated, hence to display a sample master list screen SM shown in FIG. 10(b) and select a required sample therefrom, so to set the spot format.

Upon completion of the setting of the spot format, whether the payment information in the normal registration processing is set, is checked (in step S37).

The payment information means the information indicating which means to use in order to pay a registration fee for registering a group in the information providing system S.

When the payment information is not set (NO; in step S37), a predetermined cost will not be paid, and therefore, an error is displayed to the effect that the information providing system S cannot provide a user with the information (in step S42), and the normal registration processing is finished.

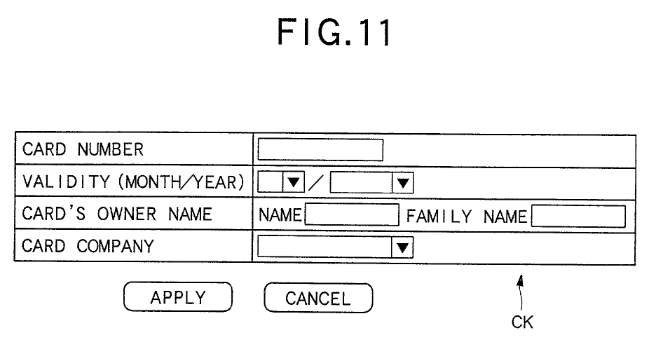

While when the payment is set (YES; in step S37), a payment screen CK, as shown in FIG. 11, is displayed on the personal computer PC, thereby entering and registering the payment information (in step S38). The content thereof is sent, for example, to a credit card company and the like thereby performing a credit examination (in step S39).

Whether there is a problem in the credit examination by the credit card company and the like, is checked (in step S40); when there is a problem (NO; in step S40), the processing will be returned to Step S37 in order to confirm whether the payment information will be set or not, again. While, when there is no problem in the credit examination (YES; in step S40), an electronic mail or a letter to the effect that the normal registration has been completed and that the information providing system S starts to supply information is sent to the manager (in step S41) and the normal registration processing is finished.

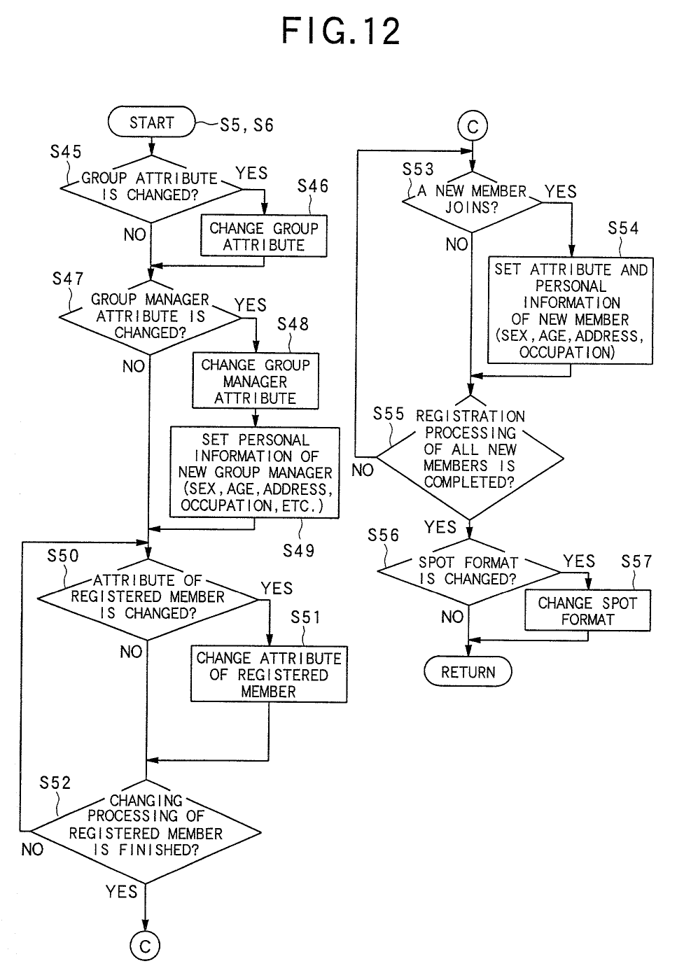

The changing processing of each attribute to be performed after the completion of the above normal registration processing and before the information providing processing described later, will be described by using FIG. 12. FIG. 12 is a flow chart showing the details of the attribute changing processing.

As illustrated in FIG. 12, in the attribute changing processing after the normal registration processing, the group registration screen GRG in the normal registration screen RG, shown in FIG. 8, including the attribute information set in the normal registration processing, is displayed on the personal computer PC, thereby checking whether it is necessary to change the group attribute (namely, the group ID and the group name) set in the above normal registration processing (in step S45). When it is necessary to change the above (YES; in step S45), the content is entered and registered in the group registration screen GRG (in step S46) and the processing will move to Step S47, while when it is not necessary to change the above (NO; in step S45), the processing will move to Step S47 directly.

The manager registration screen KRG in the displayed normal registration screen RG is displayed on the personal computer PC. Then, whether it is necessary to change the attribute of the group manager (namely, the manager's ID and name) set in the above normal registration processing, is checked (in step S47); when it is necessary to change the above (YES; in step S47), the content is entered and registered in the manager registration screen KRG (in step S48), and further when a new group manager is set in Step S48, the detailed information of the new group manager (more specifically, authority classification as a manager, sex, birth date, the type of occupation, managerial position, work place, and his or her own house) is registered (in step S49), and the processing will move to Step S50. At this time of entering the detailed information, the member management select screen KR1 shown in FIG. 9(a) is first displayed on the personal computer PC, and when a change of a group manager is selected therefrom, the detailed information input screen KR2 shown in FIG. 9(b) is displayed. By entering necessary items on the detailed information input screen KR2, the detailed information of the group manager is registered.

While, in the check of Step S47, when it is necessary to change the attribute (NO; in step S47), the processing will move to Step S50 directly.

Upon completion of the attribute changing processing of a group manager, whether the manager changes the attribute of a member (more specifically, the member's ID, name, and password) other than the manager belonging to the group set in the normal registration processing, is checked (in step S50); when the manager doesn't change the attribute (NO; in step S50), the processing will move to Step S52 directly, while when the manager changes the attribute of a member other than the manager (YES; in step S50), a change of the member other than the manager is selected on the member management select screen KR1 shown in FIG. 9(a) and the detailed information input screen KR2 shown in FIG. 9(b) is displayed, on which screen the manager newly enters the member's ID, name, and password (in step S51), and the processing will move to Step S52.

In the changing processing, if the spot information or memo information registered by a member to be changed will be changed to the public view permitted information, the manager selects “member” by using the column of the authority classification in the detailed information input screen KR2. While if the spot information or memo information registered by the member to be changed will be changed to the public view prohibited information, the manager selects “member (prohibit a public view)” and registers it. According to this processing, the manager can set whether or not to change the authority of disclosing the information within the group in each member other than the manager.

Since the personal information of a member other than the manager such as sex has been already registered in Step S33, it is not necessary to register it again here.

Whether the above changing processing has been completed as for all the registered members, is checked (in step S52); when it has not been completed (NO; in step S52), the processing will be returned to Step S50 in order to perform the registration changing processing again as for a member who has not been registered yet, while when it has been completed (YES; in step S52), whether a new member is permitted to join in the group is checked (in step S53).

In the case where a group manager recruits new members, the following method is possible.

(1) The description, “If you would like to take part in this group, please make contact with the following address” is put into the spot information already registered, and the electronic mail address or the URL (Uniform Resource Locater) of the corresponding home page is disclosed.

(2) The message, “If you would like to take part in this group, please make contact with the following address” is put into the memo information already registered and the electronic mail address or the URL (Uniform Resource Locator) of the corresponding home page is disclosed.

(3) Since a direct log-in service list described later can show the direct log-in name and the guide text, a notice of recruiting members and a contact method are described in the guide text.

In the check of Step S53, when no new member takes part in the group (NO; in step S53), the processing will move to Step S55 directly, while when a new member is allowed to take part in (YES; in step S53), the manager registers the detailed information of the new member (more specifically, authority classification as a member, sex, birth date, the type of occupation, managerial position, work place, and his or her own house) (in step S54), by using the detailed information input screen KR2 in the same way as in the case of Step S33, and the processing will move to Step S55.

Whether the above new registration processing has been completed as for all the new members, is checked (in step S55); when it has not been fully completed (NO; in step S55), the processing will be returned to Step S53 in order to perform the new registration processing again as for a new member who has not been registered yet, while when it has been completed (YES; in step S55), whether the spot format generated in the normal registration processing should be changed correspondingly to the characteristic of the group, is checked (in step S56); when it should not be changed (NO; in step S56), the attribute changing processing is finished, while when it should be changed (YES; in step S56), the spot format is changed (in step S57) and the attribute changing processing is finished. At this time, in Step S57, a new spot format is created by using the spot format setting screen SF shown in FIG. 10(a) in the same way as in Step S37.

The above series of group setting, manager information setting, and member information setting are performed by using each component chiefly within the application server AS.

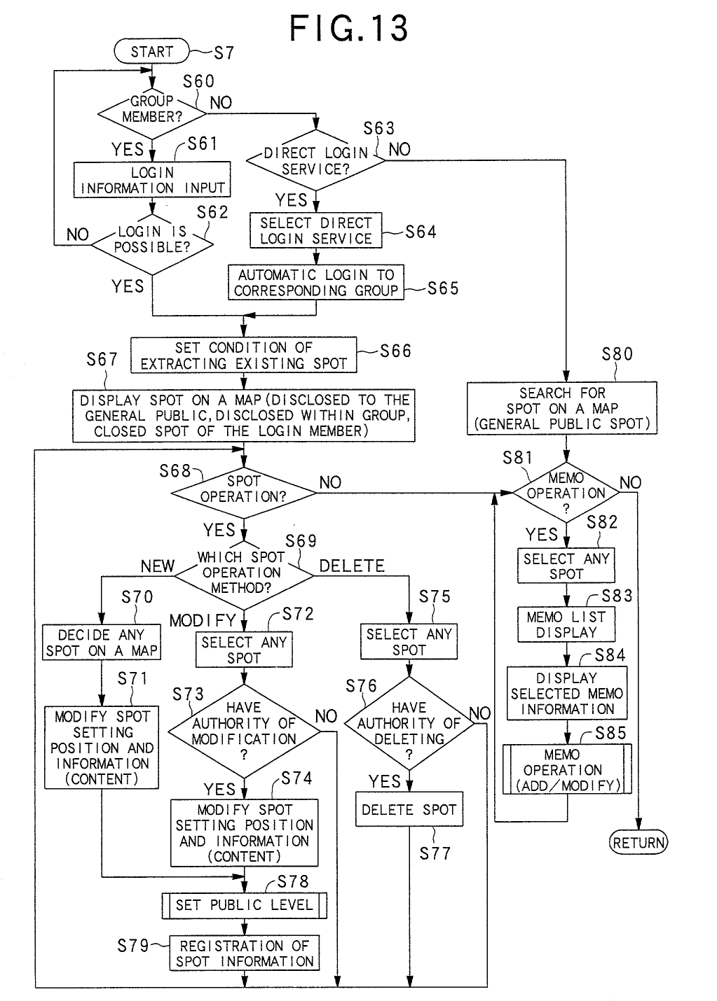

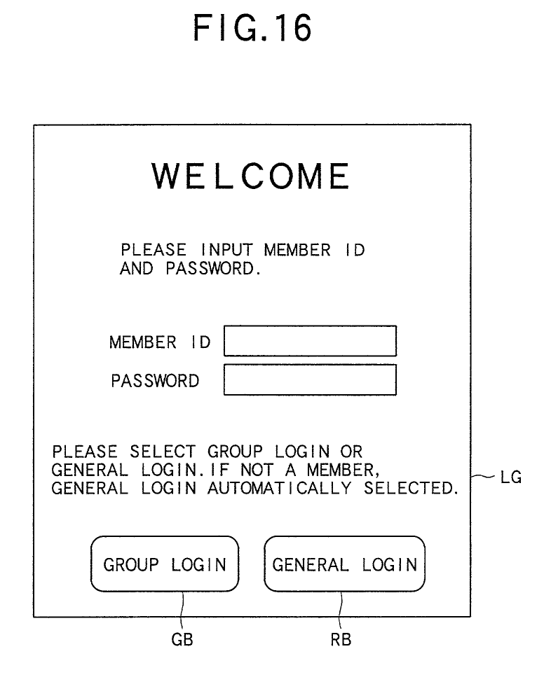

The processing in the case where a member within the group set according to the above series of the processing actually uses the information providing system S, will be described by using FIGS. 13 to 19. FIGS. 13 to 15 are flow charts showing the information providing processing, and FIGS. 16 to 19 are examples of screens displayed on the personal computer PC in the information providing processing.

As illustrated in FIG. 13, in the information providing processing of the embodiment, a login screen LG shown in FIG. 16 is displayed first, and whether a user (who browses the information) having access to the information providing server W is the above member, is checked there (in step S60).

More specifically, When the user is the above member (YES; in step S60), the member's ID and password are entered in the login screen LG, so to operate a group login button GB (in step S61), to check whether or not the login is possible (namely, the entered member's ID and password are valid or not) (in step S62). When it is judged login impossible (NO; in step S62), the processing will be returned to Step S60, where the login processing is repeated, while when it is judged login possible (YES; in step S62), the processing will move to Step S66.

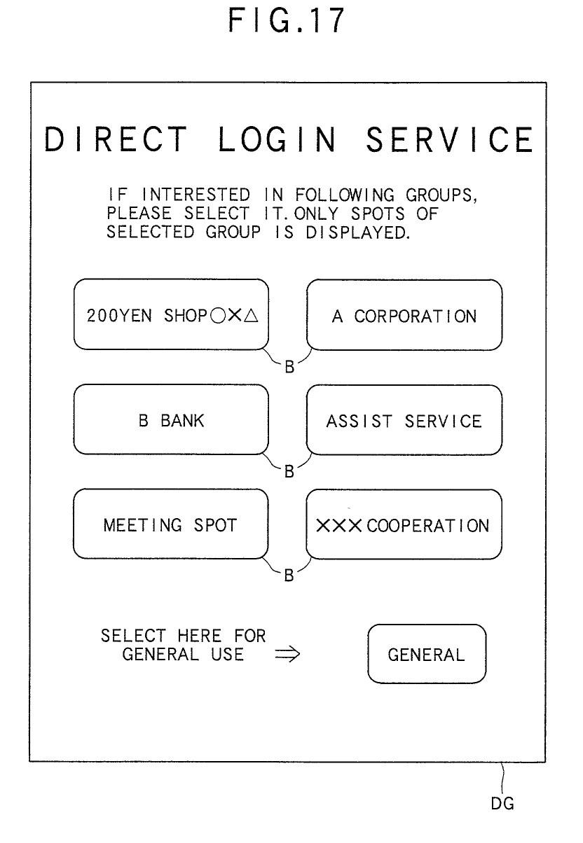

While, in the check of Step S60, when the user is not the above member, or even if the member, when the user does not log in his or her own group and the general login button RB is operated on the login screen LG (NO; in step S60), the direct login screen DG shown in FIG. 17 is displayed and whether the direct login service has been selected is checked (in step S63).

The direct login service is a service for advertising a spot within groups (the groups shown by the button B in FIG. 17) for a non-member (the general public).

Generally, a non-member would collectively browse the spot and the spot information of a public view belonging to a plurality of groups on a map. If the non-member selects a specified group in the direct login service to log in it, however, he or she can refer to only the spot of a public view within the selected group. Thus, the manager of a group can use this service for advertisement to non-members or invitation of new members.

In the check of Step S63, when the direct login service has been selected (YES; in step S63), which group to directly log in is determined by operating a button B on the direct login screen DG (in step S64). The non-member logs in the determined group (in step S65) and the processing will move to Step S66.

Upon completion of a login processing, the spot and the spot information are displayed to the login user. More specifically, a spot which can be disclosed to the user is extracted from the spots within the login group (in step S66) and displayed (in step S67). This allows the login user to browse the visible spot and the visible spot information.

More specifically, when a login user is the member, the user is allowed to browse the closed spot information which is visible only to the membership, the spot information which is visible only within the group the member belongs to, and the spot information open to the general public. When a login user is a non-member (general public) using the direct login service, the user is allowed to browse only the spot information which is visible within the group.

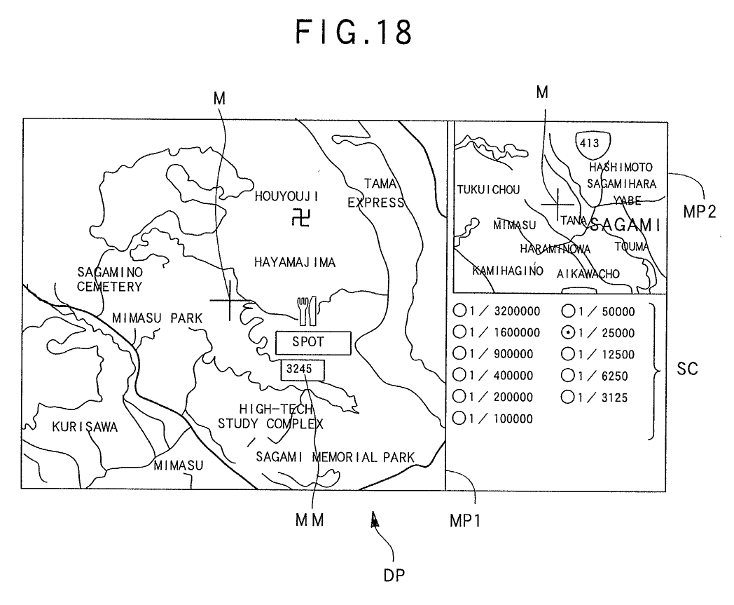

As the concrete display form of the spot information and the memo information, for example, a wide map MP2, an enlarged map MP1, and a scale selecting unit SC, as shown in FIG. 18, are displayed on the personal computer PC, and the mark M indicating the spot commonly positioned in the two maps and the name display NM are shown. In FIG. 18, the scale selecting unit SC is to specify the scale in the enlarged map MP1.

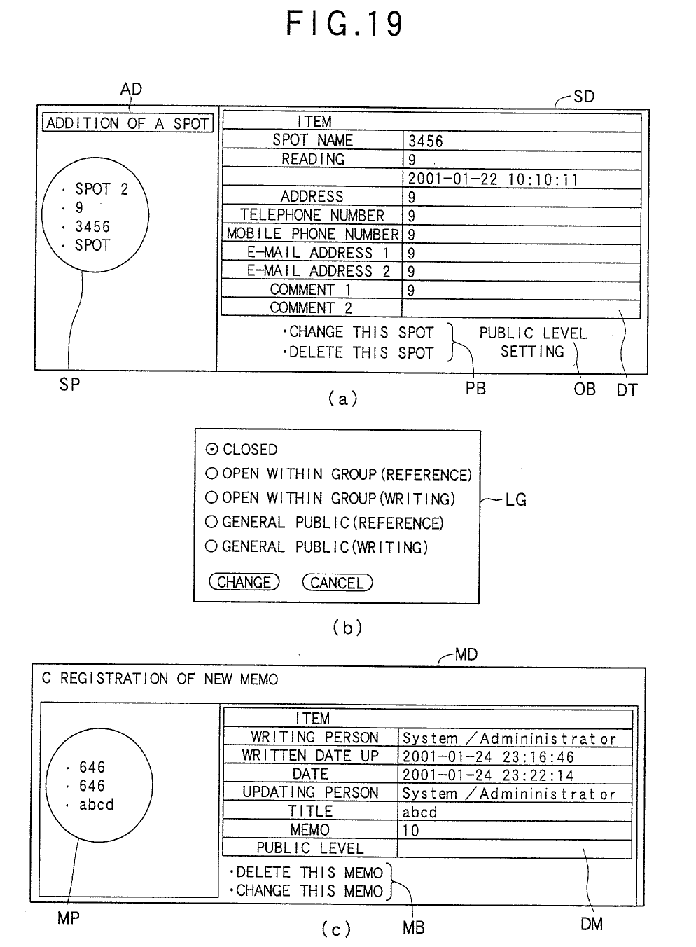

When a spot is selected on one of the maps, the spot information registered in accordance with the spot is displayed in the form, for example, as shown in FIG. 19(a), and the memo information registered similarly is displayed in the form, for example, as shown in FIG. 19(c).

At this time, the spot information display screen SD shown in FIG. 19(a) includes a spot information display unit SP for displaying the spot information registered correspondingly to the selected spot, a detail display unit DT for displaying the details of the spot information, an add button AD which is pushed down in the case of adding a spot, as described later, a change/delete button PB which is pushed down in the case of changing or deleting a spot, as described later, and a level change button OB which is pushed down in the case of changing the public level of the spot information.

Specifically, the memo information display screen MD shown in FIG. 19(c) includes a memo information display unit MP for displaying the memo information registered correspondingly to the selected spot, a detail display unit DM for displaying the details of the memo information, and a change/delete button MB which is pushed down in the case of changing or deleting the memo information, as described later.

In a state of displaying the spot information, whether an operation is added to the spot, is always monitored (in step S68).

When an operation is added to the spot (YES; in step S68), the content of the operation is checked (in step S69). In Step S68, when a user is the general public, any spot operation is not permitted (NO; in step S68).

The content of the operation to be checked in Step S69 may be one of the new registration for adding a new spot, the spot modification for modifying the content of the existing spot, and the spot deletion for deleting the existing spot together with the spot information and the memo information, and the permission/prohibition of these operations is determined by checking the authority of the current user (refer to FIGS. 2A, 2B, 2C, and 2D).

When the operation to be executed by pushing down the add button AD shown in FIG. 19(a) is judged to be of the new registration (new; in step S69), an arbitrary position on the map displayed on the personal computer PC is newly selected (in step S70), the latitude and the longitude and the name of the position are entered from the personal computer PC as the spot information (in step S71), and the processing will move to Step S78.

While, when the operation to be executed by pushing down the change/delete button B shown in FIG. 19(a) is judged to be of the modification of the spot and the spot information (modification; in step S69), an existing spot on the map displayed on the personal computer PC is selected (in step S72), and the modification authority of the spot is checked based on FIGS. 2A, 2B, 2C, and 2D (in step S73). When the user is allowed to modify the spot (namely, the user is the member) (YES; in step S73), the latitude and the longitude and the name of the spot are entered from the personal computer PC as new spot information, to modify the information (in step S74), and the processing will move to Step S78. In the check of Step S73, in the case of a modification request from a user having no modification authority (NO; in step S73), this modification is not permitted and the processing will be returned to the original Step S68.

In Step S78, the public level of the spot and the spot information newly registered or modified are established. Here, the range of the authority for setting the public level may be restricted depending on each member according to the setting of the manager, in some cases. The details of the processing in Step S78 will be described later.

Upon completion of setting the public level, the modified and added spot information is registered within the application server AS (in step S79), and the processing will be returned to Step S68 in order to perform the operation for the next spot.

While, in the check of Step S69, when the operation to be executed by pushing down the change/delete button PB shown in FIG. 19(a) is judged to be of the deletion of the spot and spot information (delete; in step S69), an existing spot on the map displayed on the personal computer PC is selected (in step S75), and the authority of deleting the spot is checked based on FIGS. 2A, 2B, 2C, and 2D (in step S76). When the user is allowed to delete (namely, the user is the member) (YES; in step S76), the spot and the spot information are deleted (in step S77), and the processing will be returned to Step S68. In the check of Step S76, when a user having no authority of deleting requests to delete them (NO; in step S76), the request is not permitted and the processing will be returned to the original Step S68.

While, in the check of Step S63, when the direct login service is not used (NO; in step S63), only the spot and the spot information permitted to be disclosed to the public on the personal computer PC are displayed on the map (in step S80), and the processing will move to Step S81.

When no spot operation is performed in Step S68 (NO; in step S68), or when Step S80 is completed, whether the change/delete button MB is pushed down on the memo information display screen MD shown in FIG. 19(c), namely, whether the displayed memo information is operated, is checked (in step S81).

When an operation is added to the memo information (YES; in step S81), a spot within the displayed range is selected (in step S82), a list of the memo information registered in accordance with the selected spot is displayed (in step S83), the memo information selected as a result of judging that an operation should be added there is displayed (in step S84), and the same operation is added (in step S85). The details of the operation will be described later.

Upon completion of the operation of the memo information, the processing will be returned to Step S81 in order to repeat the above-mentioned series of the processing as for the next memo information.

In the check of Step S81, when there is no operation for the memo information (No; in step S81), the information providing processing will be finished.

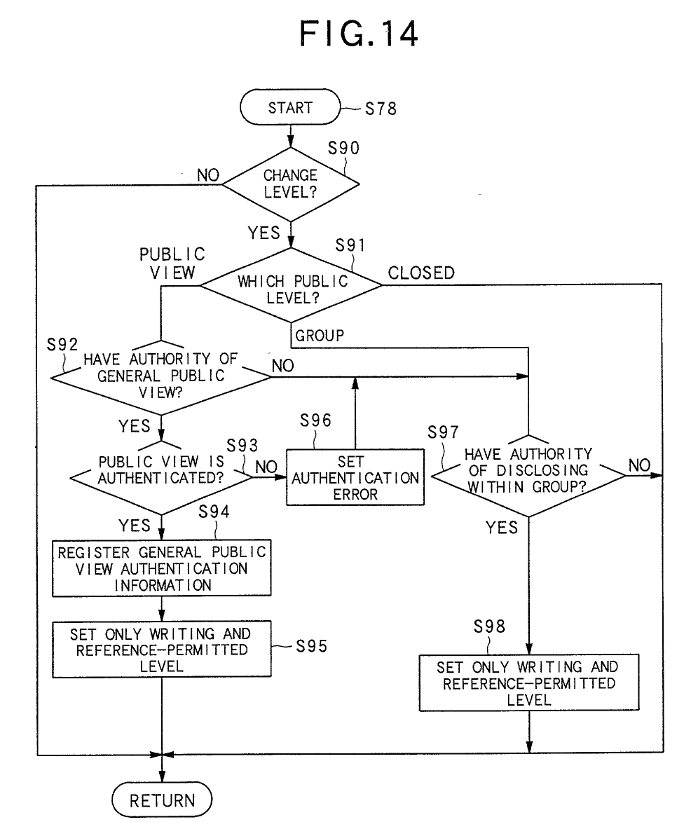

The setting of the public level in the above Step S78 will be described by using FIG. 14. FIG. 14 is a flow chart showing the setting processing of the public level.

As illustrated in FIG. 14, in the setting processing of the public level, whether the public level in the selected spot should be changed, is checked (in step S90). In the case of the new spot registration (refer to Step S70 and S71), the public level will be necessarily changed.

In the check of Step S90, when the public level is not changed (NO; in step S90), the processing will move to Step S79. While when the public level is changed (YES; in step S90), the public level to be set is specified by the registrant of the spot (in step S91). At this time, the public level setting screen LG shown in FIG. 19(b) is displayed on the personal computer PC, hence to specify the public level.

When the public level specified in Step S91 is a public view permitted (general; in step S91), whether the manager has given the authority of disclosing a spot within the group to the registrant who specified it, is checked (in step S92). When the registrant has the authority (YES; in step S92), whether the public view has been authenticated by the manager, is checked (in step S93). At this time, even if a member having the authority of a general public view, the member will not be authenticated by the manager when the public view is not adequate (NO; in step S93).

While, when the general public view has been authenticated by the manager (YES; in step S93), the information to the effect that the general public view has been authenticated is registered within the application server AS (in step S94). Further, whether only a reference is permitted or writing from the general public is permitted in the general public view, is set according to the authority classification shown in FIGS. 2A, 2B, 2C, and 2D (in step S95), the public level setting processing is finished, and the processing will move to Step S79.

While, in the check of Step S93, when the manager doesn't authenticate the general public view (NO; in step S93), the authentication error information to the same effect is set (in step S96), and the processing will move to Step S97.

When the public level specified in Step S91 is a public view permitted within group (group; in step S91), or when the registrant who specified a general public view has no authority of general public view (NO; in step S92), or when the authentication error information is set (in step S96), whether the authority of disclosing a spot belonging to the group within the group has been given to the registrant who specified it by the manager, is checked (in step S97). When the registrant has been given the authority (YES; in step S97, a general member would have the authority of permitting a public view within a group, and the manager, however, can restrict it freely.), whether only a reference is permitted or writing from another member is permitted, in the public view within the group, is set according to the authority classification shown in FIGS. 2A, 2B, 2C, and 2D (in step S98), the public level setting processing is finished, and the processing will move to Step S79.

When the public level specified in Step S91 is a closed level (closed; in step S91), or when the registrant who specified it is not given the authority of disclosing a spot belonging to a group within the group, by the manager (NO; in step S97), the public level setting processing is finished without changing the public level and the processing will move to Step S79.

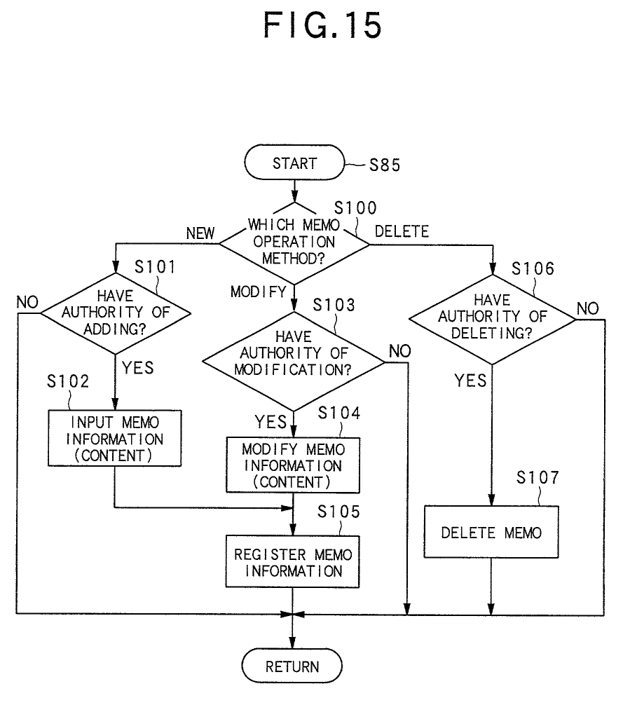

At last, the operation of the memo information in the above Step S85 will be described in detail by using FIG. 15 that is a flow chart showing the above.

As illustrated in FIG. 15, in the operation of the memo information, the operation method of the memo information corresponding to the selected spot is specified (in step S100).

When the operation method specified in Step S100 is of the new registration (new; in step S100), whether the specifying person is given the authority of adding the memo information corresponding to the spot within the group by the manager is checked (in step S101). When he or she is given the authority YES; in step S101), input of the necessary memo information is performed (in step S102), the content is registered in the application server AS (in step S105), and the operation of the memo information is finished.

In the check of Step S101, when the specifying person is not given the authority of adding the memo information by the manager (NO; in step S101), the operation of the memo information is finished without doing anything.

While, when the operation method specified in Step S100 is of the modification of the existing memo information (modification; in step S100), whether the specifying person is given the authority of modifying the memo information corresponding to the spot within the group by the manager is checked (in step S103). When he or she is given the authority (YES; in step S103), input of the necessary memo information is performed (in step S104), the content thereof is registered in the application server AS (in step S105), and the operation of the memo information is finished. When a member has the modification authority for the memo information of his or her own writing and further when the public level is set at “public view/writing-permitted within group”, he or she can modify the memo information of another member's writing.

In the check of Step S103, when the- specifying person is not given the authority of modifying the memo information by the manager (NO; in step S103), the operation of the memo information is finished without doing anything.

When the operation method specified in Step S100 is of the deletion of the existing memo information (delete; in step S100), whether the specifying person is given the authority of deleting the memo information corresponding to the spot within the group by the manager is checked (in step S106). When he or she is given the authority (YES; in step S106), the memo information is deleted (in step S107), and the operation of the memo information is finished. Here, a member has the authority of deleting the memo information of his or her own writing, and further the manager has the authority of deleting all the memo information corresponding to all the spots within the group.

In the check of Step S106, when the specifying person is not given the authority of deleting the memo information by the manager (NO; in step S106), the operation of the memo information is finished without doing anything.

In the check of Steps S101, S103, and S106, if the public level of the spot is set at “general public view/writing-permitted”, a non-member will be authorized to add, modify, or delete the information.

As mentioned above, according to the operation of the information providing system S of the embodiment, since the processing including, at least, the browsing processing and the setting processing as for the spot information and the memo information is permitted separately in a registered member and the other except the registered member, according to the content of the processing, it is possible to obtain the information of the registered spot also from a person who has browsed the spot information and the memo information, of the other except the registered member, thereby collecting useful information as a member and distributing the same to the member.

Since this system permits only a registered member to set the spot information and permits the registered member and the other except the registered member to set the memo information, it is possible to collect the memo information from the general public widely and prevent from the careless change of the spot information.

Since the setting processing of the memo information includes at least the setting processing of new memo information and the changing processing of the existing memo information, it is possible to collect the memo information from the general public more widely and distribute the same to a member.

Since this system permits a member at least to either delete or change the spot information corresponding to the spot selected by the member's own self, and to cancel the selection of the spot selected by the member's own self, a member can change the spot information corresponding to the spot selected by the member's own self at his or her own will.

Since the public level of permitting a registered member to browse and the public level of permitting the other except the registered member to browse are set different from each other, it is possible to browse the spot information visible only to the registered member and the other memo information in a distinctive way.

Since this system permits only a member who selected and registered a spot to set and change the public level corresponding to the selected spot, it is possible to change the public level at a will of the member selecting the spot and to prevent the members other than the member selecting the spot or the general public from changing the spot information corresponding to the spot without permission.

Since this system accepts registration of a member group including one or a plurality of members satisfying a predetermined condition, of the registered members, it is possible to share the spot information between not only each member but also in a member group.

Since the public level is classified into the closed level, the open within group level, and the general public level, the public level of the spot information can be set depending on the content of the visible information.

Further, since this system permits a member registered as a manager at least to either delete or change the spot information corresponding to a spot selected by the other member belonging to the member group and to cancel the selection of the spot selected by the other member, the member can collectively manage the spot information within his or her belonging member group as the manager.

In the above-mentioned embodiment, although the public level to be set is identical in the spot information and the memo information, it may be set separately. A manager of a group can restrict a spot registered by a member of the group so as to be closed.

A program corresponding to each flow chart shown in FIGS. 3, 4, 6, 7, 12, 13, 14, and 15 is stored in an information recording medium such as a flexible disk or a hard disk, and by reading and running this program in a general micro computer, the micro computer can work as the map server MS or the application serer AS of this embodiment.

The entire disclosure of Japanese Patent Application No. 2001-71190 filed on Mar. 13, 2001 including the specification, claims, drawings and summary is incorporated herein by reference in its entirety.

What is claimed is:

1. An information providing system comprising:
a map display device which displays a map through a network;
a member registration device which accepts registration of a member who satisfies a predetermined condition;
a spot recording device which records the selected spot only when a spot on the displayed map is selected by the registered member; and
a separately-permitting device which permits processing for the spot information corresponding to the recorded spot, according to the content of the processing, separately to the registered member and the other except said registered member, wherein said processing includes at least display processing for displaying the spot information through the network and setting processing for setting content of the spot information.

2. The information providing system of claim 1, in which
the spot information includes at least spot content information indicating the content of the recorded spot itself and spot associated information concerned with the recorded spot, and
the separately-permitting device permits the setting processing of the spot content information only to the registered member, and permits the setting processing of the spot associated information to the registered member and the other except said registered member.

3. The information providing system of claim 2, in which
the setting processing of the spot associated information includes at least the setting processing of new spot associated information and the changing processing of the existing spot associated information.

4. The information providing system of claim 1, in which
the separately-permitting device permits the member at least to either delete or change the spot information corresponding to the spot selected by the member's own self and to cancel the selection of the spot selected by the member's own self.

5. The information providing system of claim 1, in which
several kinds of public levels are set in the display processing, wherein said public level indicates range of a person who can view the spot information; and
the separately-permitting device sets the different public level in which the registered member is permitted to view the information from the public level in which the other except the registered member is permitted to view the information.

6. The information providing system of claim 5, in which
the separately-permitting device permits only the member having selected and recorded the spot to set and change the public level corresponding to the selected spot.

7. The information providing system of claim 5, in which
the member registration device accepts registration of a member group including one or a plurality of members who satisfy a predetermined condition, of all the registered members.

8. The information providing system of claim 7, in which
the public levels are divided into:
a private public level in which only the member having selected the spot is permitted to view the spot information corresponding to the selected spot;
a within-group public level in which only the members belonging to said member group including the member having selected the spot is permitted to view the spot information corresponding to the selected spot; and
a general public level in which everyone is permitted to view the spot information corresponding to the selected spot.

9. The information providing system of claim 7, in which
at registration of a member group, the member that is a manager of the member group and the member belonging to said member group, other than the manager, are separately registered, and
the separately-permitting device permits the member registered as the manager at least to either delete or change the spot information corresponding to the spot selected by the other member belonging to said member group of the above manager member, and to cancel the selection of the spot selected by the other member.

10. An information providing method comprising:
a map display process for displaying a map through a network;
a member registration process for accepting registration of a member who satisfies a predetermined condition;
a spot recording process for recording the selected spot only when a spot on the displayed map is selected by the registered member; and
a separately-permitting process for permitting processing for the spot information corresponding to the recorded spot, according to the content of the processing, separately to the registered member and the other except said registered member, wherein said processing includes at least display processing for displaying the spot information through the network and setting processing for setting content of the spot information.

11. The information providing method of claim 10, in which
the spot information includes at least spot content information indicating the content of the recorded spot itself and spot associated information concerned with the recorded spot, and
in the separately-permitting process, the setting processing of the spot content information is permitted only to the registered member, and the setting processing of the spot associated information is permitted to the registered member and the other except said registered member.

12. The information providing method of claim 11, in which
the setting processing of the spot associated information includes at least the setting processing of new spot associated information and the changing processing of the existing spot associated information.

13. The information providing method of claim 10, in which
in the separately-permitting process, the member is permitted at least to either delete or change the spot information corresponding to the spot selected by the member's own self and to cancel the selection of the spot selected by the member's own self.

14. The information providing method of claim 10, in which
several kinds of public levels are set in the display processing, wherein said public level indicates range of a person who can view the spot information; and
in the separately-permitting process, the public level in which the registered member is permitted to view the information is set different from the public level in which the other except the registered member is permitted to view the information.

15. The information providing method of claim 14, in which
in the separately-permitting process, only the member having selected and recorded the spot is permitted to set and change the public level corresponding to the selected spot.

16. The information providing method of claim 14, in which
registration of a member group including one or a plurality of members who satisfy a predetermined condition, of all the registered members, is accepted in the member registration process.

17. The information providing method of claim 16, in which
the public levels are divided into:
a private public level in which only the member having selected the spot is permitted to view the spot information corresponding to the selected spot;
a within-group public level in which only the members belonging to said member group including the member having selected the spot is permitted to view the spot information corresponding to the selected spot; and
a general public level in which everyone is permitted to view the spot information corresponding to the selected spot.

18. The information providing method of claim 16, in which
at registration of a member group, the member that is a manager of the member group and the member belonging to said member group, other than the manager, are separately registered, and
in the separately-permitting process, the member registered as the manager is permitted at least to either delete or change the spot information corresponding to the spot selected by the other member belonging to said member group of the above manager member, and to cancel the selection of the spot selected by the other member.

19. An information recording medium with an information providing program recorded in a computer-readable way, whereby
a computer included in an information providing system capable of providing information through a network works as:
a map display device which displays a map through a network;
a member registration device which accepts registration of a member who satisfies a predetermined condition;
a spot recording device which records the selected spot only when a spot on the displayed map is selected by the registered member; and
a separately-permitting device which permits processing for the spot information corresponding to the recorded spot, according to the content of the processing, separately to the registered member and the other except said registered member, wherein said processing includes at least display processing for displaying the spot information through the network and setting processing for setting content of the spot information.

20. An information providing program
which lets a computer included in an information providing system capable of providing information through a network, work as:
a map display device which displays a map through a network;
a member registration device which accepts registration of a member who satisfies a predetermined condition;
a spot recording device which records the selected spot only when a spot on the displayed map is selected by the registered member; and
a separately-permitting device which permits processing for the spot information corresponding to the recorded spot, according to the content of the processing, separately to the registered member and the other except said registered member, wherein said processing includes at least display processing for displaying the spot information through the network and setting processing for setting content of the spot information.
